(19) United States
(12) Patent Application Publication
(10) Pub. No.: US 2022/0106221 A1
(43) Pub. Date: Apr. 7, 2022

(54) PROTECTIVE COATING FOR MUFFLE IN OPTICAL FIBER DRAW FURNACE

(71) Applicant: CORNING INCORPORATED, Corning, NY (US)

(72) Inventors: John Michael Jewell, Wilmington, NC (US); Hoon Kim, Horseheads, NY (US); Michael Thomas Prezioso, Castle Hayne, NC (US)

(21) Appl. No.: 17/490,407

(22) Filed: Sep. 30, 2021

Related U.S. Application Data
(60) Provisional application No. 63/088,075, filed on Oct. 6, 2020.

(51) Int. Cl. C03B 37/029; C03B 37/03; C01B 32/21; C04B 35/56; C04B 35/622

(52) U.S. Cl. CPC C03B 37/029; C03B 37/03; C01B 32/21; C04B 35/5607; C04B 2235/9669; C03B 2205/60; C04B 2235/3839; C04B 2235/3826; C04B 35/62222

(57) ABSTRACT

A muffle for an optical fiber draw furnace. The muffle including an inner surface and an outer surface, the inner surface forming an inner cavity. A protective coating is disposed on the inner surface, the protective coating having a melting point of about 1850° C. or greater. Furthermore, an absolute difference between a coefficient of thermal expansion of the protective coating and a coefficient of thermal expansion of a material of the muffle is 2.0 ppm/° C. or less over a temperature range from 25° C. to 1000° C.

This application claims the benefit of priority to U.S. Provisional Patent Application Ser. No. 63/088,075 filed on Oct. 6, 2020, the content of which is relied upon and incorporated herein by reference in its entirety.

### FIELD OF THE DISCLOSURE

The present disclosure is generally directed to a protective coating for use in an optical fiber draw furnace. More particularly, the present disclosure relates to a protective coating for a muffle in an optical fiber draw furnace, an optical fiber draw furnace having a muffle with a protective coating disposed thereon, and methods of operating a muffle, in an optical fiber draw furnace, with a protective coating disposed thereon.

### BACKGROUND OF THE DISCLOSURE

A draw furnace is conventionally used to house an optical fiber during a drawing procedure, which involves melting and stretching an optical fiber preform to achieve a target optical fiber diameter. Various properties, including furnace temperature, preform position, and pulling speed, are controlled in order to produce an optical fiber with a constant diameter. During the drawing procedure, the preform is disposed within a muffle tube of the draw furnace. A support member may be used to secure the preform within the muffle tube. A lower end portion of the preform is then heated by a heater, and the preform is drawn downward, thus forming the optical fiber.

Optical fiber preforms are typically formed of consolidated silica glass, which includes a series of concentric regions of silica glass that differ in the level or type of dopant. Control of the spatial distribution, concentration, and/or type of dopant in the preform creates regions that differ in refractive index. These differences in refractive index define different functional regions in the produced optical fiber (e.g. core vs. cladding, low index depressions, tailored index profiles).

### SUMMARY OF THE DISCLOSURE

During the drawing procedure, the optical fiber may be heated to very high temperatures such as, for example, about 1850° C. to about 2200° C. Thus, the material of the muffle must be sufficient to withstand such high temperatures. Most typically, muffles are formed from graphite because this material can withstand such high temperatures and can also be quickly heated to a desired temperature. Additionally, graphite muffles can be manufactured in very large sizes, thus enabling a furnace to accept large diameter preforms, which reduce overall manufacturing costs.

However, as a result of the high temperatures required for the draw process, silica from the preform will continuously evaporate, releasing silicon monoxide gas and oxygen gas. For example, silica vapor evaporates from the perform and silicon monoxide and oxygen gas from the vapor diffuse to the graphite muffle. These gases can then react with the graphite muffle, oxidizing and altering the surface properties and structure of the muffle.

It is known in the art to remove any oxidation from a muffle by manually brushing the muffle or by using an ultrasonic or sonic cleaning method. However, such cleaning processes require that the furnace be turned off long enough to cool the furnace before starting the cleaning process. Therefore, these cleaning processes are time consuming and, thus, waste time and money while the furnace is inactive and turned off.

The present disclosure is directed to a protective coating for a muffle that reduces and/or prevents the need for such cleaning processes. The protective coatings of the present disclosure provide a barrier to oxidation of the muffle formed by, for example, silicon monoxide gas or oxygen gas.

According to one embodiment, a muffle for an optical fiber draw furnace is provided. The muffle includes an inner surface and an outer surface, the inner surface forming an inner cavity. A protective coating is disposed on the inner surface, the protective coating having a melting point of about 1850° C. or greater. Furthermore, an absolute difference between a coefficient of thermal expansion of the protective coating and a coefficient of thermal expansion of a material of the muffle is 2.0 ppm/° C. or less over a temperature range from 25° C. to 1000° C.

According to other embodiments, a muffle for an optical fiber draw furnace is provided. The muffle includes an inner surface and an outer surface, the inner surface forming an inner cavity. A protective coating is disposed on the inner surface, the protective coating having a melting point of about 1850° C. or greater. Furthermore, the protective coating has a vapor pressure in an inert environment at about 1800° C. of about 2.0×10⁻⁸ Pa or less.

### BRIEF DESCRIPTION OF THE DRAWINGS

FIG. 1 is a schematic diagram illustrating a draw furnace assembly, according to embodiments of the present disclosure;

FIG. 2 is a schematic diagram illustrating a muffle of the draw furnace assembly of FIG. 1, according to embodiments of the present disclosure;

FIG. 3 is a cross-sectional view illustrating a portion of the muffle of FIG. 2 with a protective coating disposed thereon, according to embodiments of the present disclosure;

FIG. 4 is another cross-sectional view illustrating a portion of the muffle of FIG. 2 with a protective coating disposed thereon, according to embodiments of the present disclosure;

FIG. 5 is another cross-sectional view illustrating a portion of the muffle of FIG. 2 with a protective coating disposed thereon, according to embodiments of the present disclosure;

FIG. 6 is another cross-sectional view illustrating a portion of the muffle of FIG. 2 with a protective coating disposed thereon, according to embodiments of the present disclosure; and

FIG. 7 shows an enlarged view of a portion of the protective coating of FIG. 6.

### DETAILED DESCRIPTION

Additional features and advantages of the disclosure will be set forth in the detailed description which follows and will be apparent to those skilled in the art from the description, or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

It will be understood by one having ordinary skill in the art that construction of the described disclosure, and other components, is not limited to any specific material. Other exemplary embodiments of the disclosure disclosed herein may be formed from a wide variety of materials, unless described otherwise herein.

It is also important to note that the construction and arrangement of the elements of the disclosure, as shown in the exemplary embodiments, is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel and nonobvious teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures, and/or members, or connectors, or other elements of the system, may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present disclosure. Other substitutions, modifications, changes, and omissions may be made in the design, operating conditions, and arrangement of the desired and other exemplary embodiments without departing from the spirit of the present disclosure.

Reference will now be made in detail to the present preferred embodiments of the disclosure, examples of which are illustrated in the accompanying drawings. Whenever possible, the same reference numbers will be used throughout the drawings to refer to the same or like parts.

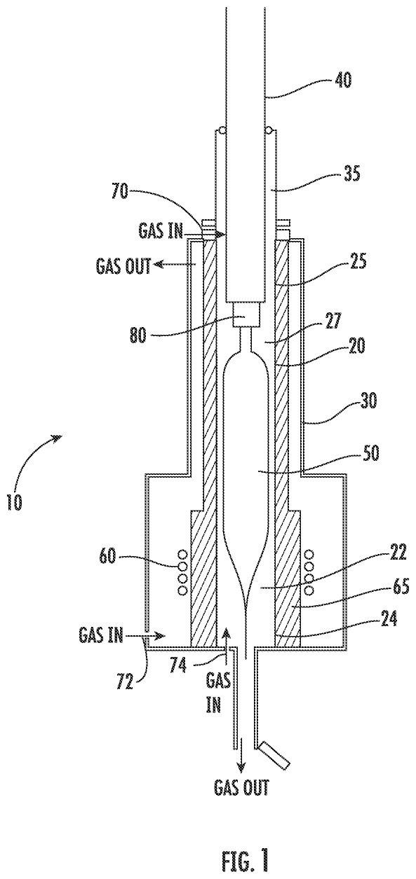

Referring now to FIG. 1, an exemplary optical fiber draw furnace system is shown generally designated by reference numeral 10, according to one example. Draw furnace 10 includes a muffle 20 disposed within an outer can 30. A downfeed handle 40 is moveably positioned within an inner cavity 27 of muffle 20 to support an optical fiber preform 50.

Muffle 20 is a tubular member that comprises a first end portion 24 and a second end portion 25, as shown in FIG. 1. A top hat 35 is positioned above second portion 25 of muffle 20 and provides sealing capabilities with muffle 20 and downfeed handle 40, as is known in the art. As shown in FIG. 1, muffle 20 and top hat 35 form inner cavity 27, through which downfeed handle 40 is moveably disposed during drawing of preform 50. Inner cavity 27 forms a furnace cavity 22 at a first end of the cavity near heater 60.

Heater 60 is disposed within outer can 30 adjacent to the first end portion 24 of muffle 20. Heater 60 is thermally coupled to muffle 20 to create a hot zone within furnace cavity 22. The hot zone may have a temperature in a range from about 1800° C. to about 2200° C. In some embodiments, the hot zone may have a temperature of about 1800° C., about 1900° C., about 2000° C., or about 2100° C., or any range having any two of these values as endpoints. As discussed further below, the heat of the hot zone is sufficient to decrease the viscosity of preform 50 in order to draw preform 50 into an optical fiber. In some embodiments, heater 60 comprises an induction coil.

Preform 50 may be attached to and hung from downfeed handle 40 using a support member 80. It is contemplated that support member 80 is a component of downfeed handle 40, or is a separate component coupled to downfeed handle 40. Support member 80 is configured to support preform 50. In some embodiments, support member 80 is a piece of glass welded to downfeed handle 40. Additionally or alternatively, support member 80 may include a slot to which preform 50 is attached. However, it is also contemplated that any suitable configuration may be used to attach preform 50 to downfeed handle 40.

Muffle 20 may be comprised of a ceramic material, a refractory material, and/or a refractory metal such as, for example, graphite, zirconia, binders, alumina, mullite, quartz, silicon carbide, silicon nitride, and/or combinations thereof. Therefore, muffle 20 may be formed of carbon, which can react with the silica and oxygen released from preform 50. For example, as discussed above, due to the high temperatures required during a draw process, silica from preform 50 evaporates during the draw process, releasing silicon monoxide gas and oxygen gas. As shown below in Equations (I) and (II) below, the silicon monoxide gas and the oxygen gas then react with the carbon of the graphite muffle and form an oxidation film or residue on muffle 20. As discussed further below, muffle 20 further comprises a protective coating that prevents/reduces such oxidation of muffle 20.

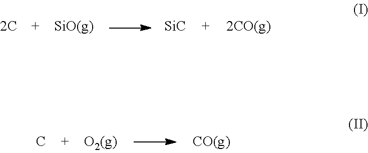

Furthermore, muffle 20 is configured to retain heat within draw furnace 10, as well as protect other components from excess temperatures. For example, muffle 20 may have insulating properties sufficient to maintain the elevated temperature of the hot zone within furnace cavity 22. In some embodiments, an insulation 65 surrounds muffle 20 in order to further increase the retention of heat within furnace cavity 22. As shown in FIG. 1, insulation 65 is disposed between muffle 20 and the induction coil of heater 60 and is disposed between muffle 20 and outer can 30. Furthermore, insulation 65 may, in some embodiments, extend in length from heater 60 to second end portion 25 of muffle 20.

As is known in the art, one or more process gases may be inserted or injected into draw furnace 10 to reduce oxidation of the components of draw furnace 10, including muffle 20. More specifically, process gas is injected into draw furnace 10 so that ambient air does not enter draw furnace 10 during a drawing procedure. Therefore, oxygen from the ambient air is prevented from reacting with muffle 20 during the drawing procedure. However, as discussed above, oxidation of muffle 20 may still occur due to silica evaporation and decomposition from preform 50. The process gases may include, for example, nitrogen, argon, helium, and/or a combination of these gases.

Outer can 30 includes one or more gas inlet ports to inject the process gas into cavity 27. For example, as shown in FIG. 1, outer can 30 includes a first gas inlet port 70, a second gas inlet port 72, and a third gas inlet port 74. The process gas may be injected between an outer wall of muffle 20 and an inner wall of can 30. The process gas may also be injected into inner cavity 27, as shown in FIG. 1.

As preform 50 moves with downfeed handle 40 within muffle 20 and is lowered towards lower heater 60, an optical fiber may be drawn therefrom. Preform 50 may be composed of any well-known glass or other material and may be doped suitable for the manufacture of optical fibers. In some embodiments, preform 50 includes a core and a cladding. As preform 50 reaches the hot zone of heater 60, the viscosity of preform 50 is lowered such that an optical fiber may be drawn from preform 50. As preform 50 is continuously consumed during the drawing process, downfeed handle 40 may be continuously lowered such that new portions of preform 50 are exposed to the hot zone created by heater 60. The optical fiber is drawn from preform 50 out through a bottom of draw furnace 10 and may be wound onto a spool. In some embodiments, the optical fiber has a diameter of about 125 microns.

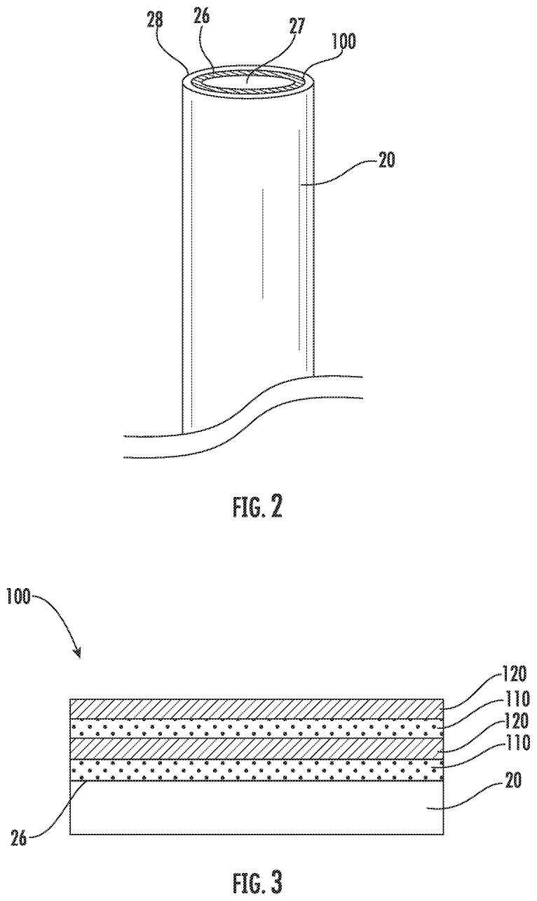

As discussed above, muffle 20 comprises a protective coating that prevents/reduces oxidation of muffle 20, even when muffle 20 is exposed to the high heat from heater 60. Thus, the protective coating provides a barrier to oxidation of muffle 20 as described by Equations (1) and (2). Referring to FIG. 2, muffle 20 comprises a tubular member having an inner surface 26 and an outer surface 28 that form inner cavity 27. Protective coating 100 is disposed along inner surface 26 of muffle 20.

In some embodiments, protective coating 100 is disposed on inner surface 26 of muffle 20 along an entire length of muffle 20, from first end portion 24 to second end portion 25. In other embodiments, protective coating 100 is disposed on a portion of muffle 20 that is less than an entire length of muffle 20. For example, protective coating 100 may be disposed only for the length of the hot zone within furnace cavity 22. This length may range from about 5 inches to about 30 inches, or about 10 inches to about 25 inches, or about 12 inches to about 20 inches, or about 12 inches to about 18 inches, or about 12 inches to about 16 inches, or about 15 inches. Thus, for example, protective coating 100 may be disposed along a portion of muffle 20 that is about 5%, or about 8%, or about 10%, or about 15%, or about 18%, or about 20%, or 25%, or about 28%, or about 30% of the entire length of muffle 20.

In some embodiments, protective coating 100 is disposed along muffle 20 for at least a portion of the hot zone within furnace cavity 22 and protective coating 100 has a sufficiently high melting point and sufficiently low vapor pressure so that the coating can withstand the high temperature within the hot zone, which is generated from heater 60. Thus, the coating will not degrade due to the heat from heater 60. For example, protective coating 100 has a melting point of about 1800° C. or higher, or about 1850° C. or higher, or about 1900° C. or higher, or about 2000° C. or higher, or about 2200° C. or higher, or about 2400° C. or higher, or about 2600° C. or higher, or about 2800° C. or higher, or about 3000° C. or higher, or about 3200° C. or higher, or about 3400° C. or higher, or about 3600° C. or higher, or about 3800° C. or higher. In some embodiments, protective coating 100 has a melting point of about 1850° C., or about 1890° C., or about 2700° C., or about 2800° C., or about 3100° C., or about 3880° C., or any range having any of these values as endpoints.

Protective coating 100 may also have a low vapor pressure, even when exposed to the high temperatures from heater 60, so that it remains stable within muffle 20. In some embodiments, the vapor pressure of protective coating 100 in an inert environment at about 1730° C. is about 2.5×10⁻⁶ Pa or less, or about 2.4×10⁻⁶ Pa or less, or about 2.2×10⁻⁶ Pa or less. In some embodiments, the vapor pressure of protective coating 100 in an inert environment at about 1800° C. is about 2.0×10⁻⁸ Pa or less, or about 1.5×10⁻⁸ Pa or less, or about 1.2×10⁻⁸ Pa or less. In some embodiments, the vapor pressure of protective coating 100 in an inert environment at about 1900° C. is about 6.0×10⁻⁸ Pa or less, or about 5.8×10⁻⁸ Pa or less, or about 5.5×10⁻⁸ Pa or less. In some embodiments, the vapor pressure of protective coating 100 in an inert environment at about 2000° C. is about 3.0×10⁻⁷ Pa or less, or about 2.9×10⁻⁷ Pa or less, or about 2.8×10⁻⁷ Pa or less. In some embodiments, the vapor pressure of protective coating in an inert environment at about 2100° C. is about 2.0×10⁻⁶ Pa or less, or about 1.8×10⁻⁶ Pa or less, or about 1.6×10⁻⁶ Pa or less. In some embodiments, the vapor pressure of protective coating 100 in an inert environment at about 2350° C. is about 5.0×10⁻⁶ Pa or less, or about 4.5×10⁻⁶ Pa or less, or about 4.0×10⁻⁶ Pa or less. In some embodiments, the vapor pressure of protective coating 100 in an inert environment at about 2500° C. is about 2.5×10⁻⁶ Pa or less, or about 2.2×10⁻⁶ Pa or less, or about 2.0×10⁻⁶ Pa or less. The above-disclosed vapor pressures are each measured in an inert environment and, therefore, represent a vapor pressure of the material itself of protective coating 100.

In some embodiments, the vapor pressure after oxidation of protective coating 100 at about 2300° C. is about 8 Pa or less, or about 6 Pa or less, or about 4 Pa or less, or about 3.8 Pa or less, or about 3.6 Pa or less, or about 3.4 Pa or less, or about 3.2 Pa or less, or about 3.0 Pa or less, or about 2.8 Pa or less.

The vapor pressures disclosed herein were measured using a Langmuir vaporization technique that included supporting the sample to be measured on tungsten rods and directly heating the sample through induction heating. The temperature of the sample was measured using a disappearing-filament optical pyrometer, which was calibrated using a standard tungsten filament lamp with all optical elements in the light path. The vapor pressure of the sample was specifically measured by first weighing the sample, applying a pressure of 1×10⁻⁶ torr to the sample, and then heating the sample at a specific temperature for a specific length of time, followed by rapid cooling and then reweighing. The vapor pressure was calculated by dividing the weight loss (in grams) by the specific heating time (in seconds) and the total surface area of the sample (in square centimeters).

Protective coating 100 comprises a metal or metal alloy including, for example, a transition metal to prevent/reduce the oxidation of muffle 20. Exemplary metals include hafnium (Hf), zirconium (Zr), tantalum (Ta), iridium (Ir), rhenium (Re), beryllium (Be), magnesium (Mg), and/or thorium (Th) in order to meet the above-disclosed melting point and vapor pressure requirements. Exemplary metal alloys include metal carbides, metals oxides, metal borides, and/or metal silicates of any of the above-disclosed metals including, for example, hafnium carbide (HfC), hafnium dioxide (HfO₂), hafnium diboride (HfB₂), zirconium carbide (ZrC), zirconium dioxide (ZrO₂), tantalum carbide (TaCx), tantalum pentoxide (Ta₂O₅), tantalum hafnium carbide (TaₓHf_{y-x}C_{y}, such as Ta₄HfC₅), hafnium silicate (HfSiO₄), beryllium oxide (BeO), magnesium oxide (MgO), thorium oxide (ThO₂), and yttrium oxide (Y₂O₃).

In some embodiments, protective coating 100 comprises a metal or metal alloy, as disclosed above, doped with one or more additional components. Such dopants may help to reduce the grain size (i.e., average particle diameter) of protective coating 100, which reduces degradation of the coating. As discussed above, as a result of the high temperatures required for the draw process, silica from preform 50 will continuously evaporate, releasing silicon monoxide gas and oxygen gas. These gases may then react with protective coating 100 and, over time, degrade protective coating 100 by slowly etching into the coating. However, the dopants of protective coating 100 reduce the grain size of protective coating 100 and, therefore, reduce such etching of the coating. More specifically, the smaller grain size of the coating increases the grain-boundary surface between protective coating 100 and the surrounding atmosphere. This increased grain-boundary surface in turn provides a larger surface area that impedes and defends against any etching of protective coating 100.

The one or more dopants may be metal or metal alloys, as disclosed above. For example, in some embodiments, protective coating 100 comprises hafnium doped with tantalum or hafnium doped with tantalum and carbide. Tantalum may be an especially beneficial dopant because it not only reduces the grain size of protective coating 100 but it also provides increased thermal stability to the coating. The one or more dopants may be incorporated into protective coating 100 by, for example, intermixing with the other component(s) of protective coating 100. In yet other embodiments, the one or more dopants may form a laminate structure with the other component(s) of protective coating 100. For example, protective coating 100 may be comprised of one or more layers or hafnium carbide (HfC) laminated with one or more layers doped with tantalum carbide (TaC). In such embodiments in which the dopants form a laminate structure, the dopants may be deposited by any well-known method such as, for example, chemical vapor deposition (CVD), physical vapor deposition (PVD), e-beam coating, or spray coating.

The one or more dopants may reduce the average particle diameter of protective coating 100 by about 50% or more, or about 60% or more, or about 70% or more, or about 80% or more, or about 90% or more. In some embodiments, the dopants reduce the average particle diameter in a range from about 50% to about 90%, or from about 60% to about 80%. In some embodiments, the one or more dopants may reduce the average particle diameter to be about 10 microns or less, or about 8 microns or less, or about 5 microns or less, or about 3 microns or less, or about 2.5 microns or less, or about 2.25 microns or less, or about 2 microns or less, or about 1.75 microns or less, or about 1.5 microns or less, or about 1.25 microns or less, or about 1 micron or less, or about 0.75 microns or less, or about 0.5 microns or less, or about 0.25 microns or less, or about 0.2 microns or less, or about 0.1 microns or less. The average particle diameter, as discussed herein, was determined using a Scanning Electron Microscope (SEM). Furthermore, the amount of dopant in protective coating 100 may be from about 30 at. % to about 70 at. % or from about 40 at. % to about 60 at. %, where at. % means atomic %. In some embodiments, protective coating 100 is doped with tantalum in an amount of 30 at. % such that protective coating 100 has a thickness in a range from about 3 microns to about 20 microns. In yet additional embodiments, the thickness is within a range from about 8 microns to about 15 microns.

In some embodiments, protective coating 100 is comprised of a laminate film that includes first layers 110 comprised of a first material and second layers 120 comprised of a second material such that the first material is different from the second material. The second material of second layers 120 may include the metal or metal alloy materials discussed above (which may or may not be doped, as discussed above). Therefore, in some embodiments, second layers 120 may include an additional dopant that may be incorporated into second layer 120 either through intermixing or as a laminate structure.

FIG. 3 provides an exemplary laminate structure of protective coating 100. In this embodiment, protective coating 100 comprises one or more first layers 110 and one or more second layers 120. First layers 110 comprise a buffer layer, and second layers 120 comprise a metal or metal alloy layer as discussed above. Thus, second layers 120 prevent/reduce the oxidation of muffle 20 (as discussed above) while first layers 110 promote adhesion of second layers 120 to the material of muffle 20. In some embodiments, such as in the embodiment of FIG. 3, second layer 120 is disposed most outwardly of all the layers of protective coating 100, relative to inner surface 26 of muffle 20, in order to prevent the oxidizing effect on inner surface 26 of muffle 20. In other embodiments, first layer 110 is disposed most outwardly of all the layers of protective coating 100.

As shown in FIG. 3, protective coating 100 comprises separate first and second layers 110, 120 as alternating and repeating layers forming a layered stack. Protective coating 100 may be formed of an equivalent number of first and second layers 110, 120. In some embodiments, first layer 110 is disposed directly adjacent to and directly contacts inner surface 26 of muffle 20. Such may aid in the adhesion between protective coating 100 and muffle 20 by securely anchoring protective coating 100 to muffle 20.

As discussed above, first layer 110 forms a buffer layer that improves the adhesion between muffle 20 and second layer 120. For example, the material of first layers 110, the thickness of first layers 110, and/or the number of separate first layers 110 may be selected to adjust the coefficient of thermal expansion (CTE) of protective coating 100 so that it more closely matches the CTE of the material of muffle 20, thus promoting adhesion between protective coating 100 and muffle 20. Additionally, first layer 110 helps to improve the mechanical stability of protective coating 50, for example by reducing any crack resistance and increasing fracture toughness of protective coating 100. In some embodiments, first layer 110 is comprised of silicon carbide (SiC), zirconium carbide (ZrC), tantalum carbide (TaC), or combinations thereof.

Although the embodiment of FIG. 3 shows a protective coating with two individual first layers 110 and two individual second layers 120, it is also contemplated that more or less layers may be used. For example, protective coating 100 may include only one layer of each of first and second layers 110, 120 (thus providing a coating with two layers total). In other embodiments, protective coating 100 includes three, four, five, six, seven, eight, nine, ten, or more individual layers of each of first and second layers 110, 120. Therefore, protective coating 100 may have a total number of layers ranging from two or more, four or more, six or more, eight or more, ten or more, twelve or more, fourteen or more, sixteen or more, eighteen or more, or twenty or more. It is also contemplated that protective coating 100 may, in some embodiments, include an uneven number of layers. For example, protective coating 100 may include more first layers 110 than second layers 120, or more may include more second layers 120 than first layers 110.

FIG. 4 provides another exemplary embodiment of a protective coating that includes four individual first layers 110 (i.e., layers 111, 112, 113, 114) and four individual second layers 120 (i.e., 121, 122, 123, 124). First layer 111 directly contacts inner surface 26 of muffle 20 and second layer 124 forms an outermost layer of protective coating 100 in this embodiment.

In some embodiments, the individual second layers 120 may have a smaller thickness than the individual first layers 110. Each individual second layer 120 may have a thickness in a range from about 0.1 micron to about 100 microns, or about 0.25 microns to about 75 microns, or about 0.50 microns to about 50 microns, or about 0.75 microns to about 25 microns, or about 1 micron to about 20 microns, or about 2 microns to about 15 microns, or about 3 microns to about 10 microns, or about 4 microns to about 8 microns, or about 5 microns, or about 6 microns, or about 7 microns.

Individual first layers 110 may be at least about 25%, or at least about 50%, or at least about 75%, or at least about 100%, or at least about 125%, or at least about 150%, or at least about 175%, or at least about 200%, or at least about 225%, or at least about 250%, or at least about 275%, or at least about 300%, or at least about 325%, or at least about 350%, or at least about 375%, or at least about 400% thicker than individual second layers 120. For example, in the embodiment of FIG. 4, first layers 111, 112, 113, 114 are each about 100% thicker than each of second layers 121, 122, 123, 124. In this embodiment, second layers 121, 122, 123, 124 are each about 5 microns in thickness and first layers 111, 112, 113, 114 are each about 10 microns in thickness.

In some embodiments, each individual first layer 110 may have a thickness in a range from about 0.2 microns to about 40 mm, or about 10 microns to about 5 mm, or about 100 microns to about 1 mm, or about 200 microns to about 800 microns. It is also contemplated that, in some embodiments, one or more first layers 110 have the same thickness as one or more second layers 120.

Further one or more individual first layers 110 may have a different thickness from the other first layers 110 in protective coating 100. For example, with reference to FIG. 4, layer 112 may be thinner than layer 111 and thicker than layers 113 and 114. Similarly, one or more individual second layers 120 may have a different thickness from other second layers 120. For example, also with reference to FIG. 4, layer 223 may be thinner than layer 224 and thicker than layers 221 and 222.

A total thickness of protective coating 100 may be in a range from about 2 microns to about 100 mm, or about 5 microns to about 5 mm, or about 10 microns to about 4 mm, or about 50 microns to about 2 mm, or about 100 microns to about 1 mm. In some embodiments, the total thickness of protective coating 100 is less than about 800 microns, or less than about 600 microns, or less than about 400 microns, or less than about 200 microns.

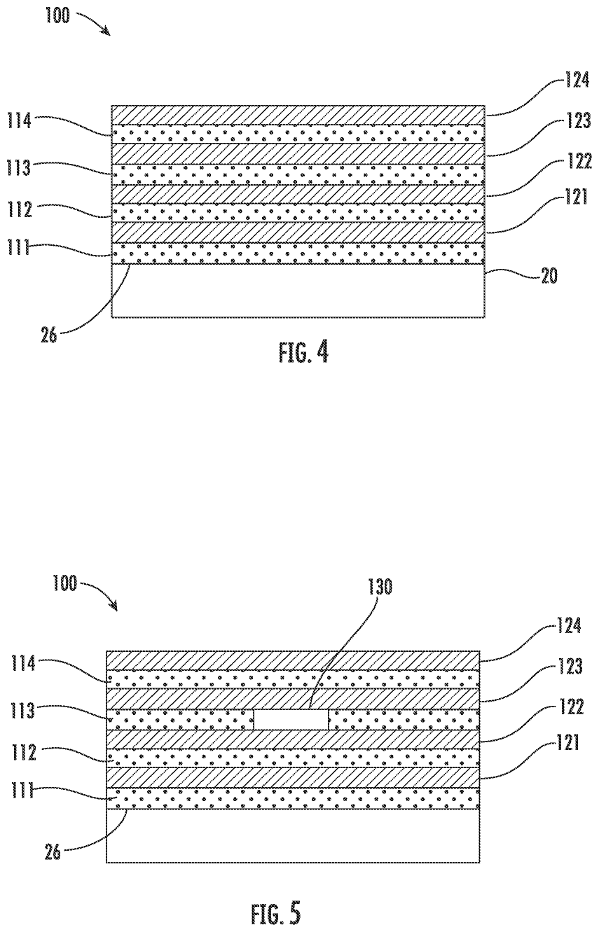

Each individual first layer 110 and each individual second layer 120 may be applied on muffle 20 to form a continuous layer along a length of inner surface 26 of muffle 20. Thus, each layer may be applied so that no gaps are formed in the separate layers along the length of inner surface 26. However, it is also contemplated, in some embodiments, that one or more layers may include one or more gaps. FIG. 5 shows an exemplary embodiment in which layer 113 includes a gap 130 that may be filled with a different material than the material of layer 113. Gap 130 may be a void that is filled with (or at least partially filled with) one or more gases such as hydrogen gas, hydrocarbon gas, carbon monoxide gas, carbon gas, oxygen gas, silicon oxide gas, nitrogen gas, argon gas, helium gas, and the gases of ambient air. In other embodiments, gap 130 may be filled with (or at least partially filled with) one or more of the materials of first layer 110 and/or second layer 120.

As shown in FIGS. 3-5, layers 110 and 120 may be directly bonded to each other and directly bonded to muffle 20. However, it is also contemplated that one or more additional layers may be disposed between first layers 110 and second layers 120 and/or between muffle 20 and protective coating 100. These additional layers may include an adhesion layer comprised of, for example, hafnium silica carbide (HfₓSi_{y}C_{z}), tantalum hafnium carbide (TaₓHf_{y-x}C_{y}, such as Ta₄HfC₅), hafnium yttrium carbide (HfₓY_{y}C_{z}), hafnium beryllium carbide (HfₓBe_{y}C_{z}), hafnium thorium carbide (HfₓTh_{y}C_{z}), hafnium aluminum carbide (HfₓAl_{y}C_{z}), hafnium zirconium carbide (HfₓZr_{y}C_{z}), hafnium lanthanum carbide (HfₓLa_{y}C_{z}), and hafnium magnesium carbide (HfₓMg_{y}C_{z}).

It is also noted that the individual layers of first and second layers 110, 120 may each include a single layer or may include one or more sub-layers. Such sub-layers may be in direct contact with one another. The sub-layers may be formed from the same material or two or more different materials. In one or more alternative embodiments, the sub-layers may have intervening layers of different materials disposed therebetween. In one or more embodiments a layer may include one or more contiguous and uninterrupted layers and/or one or more discontinuous and interrupted layers (i.e., a layer having different materials formed adjacent to one another). In some embodiments, the sub-layers of first layers 110 may form a laminate structure within each individual first layer 110. Similarly, the sub-layers of second layers 120 may form a laminate structure within each individual second layer 120. For example, as discussed above, second layers 120 may include an additional dopant that is incorporated into the coating as a laminate.

First and second layers 110, 110 (and their sub-layers) may be formed by any known method in the art, including discrete deposition or continuous deposition processes. In one or more embodiments, the layers may be formed using chemical vapor deposition (CVD), physical vapor deposition (PVD), e-beam coating, or spray coating.

As discussed above, the material(s) of first layers 110 may have a lower coefficient of thermal expansion (CTE) than the material(s) of second layers 120. Therefore, the incorporation of first layers 110 in protective coating 100 reduces the overall CTE of protective coating 100. More specifically, the material of first layers 110, the thickness of first layers 110, and/or the number of individual first layers 110 may be chosen to adjust the CTE of protective coating 100 so that it more closely matches the CTE of the material of muffle 20, thus promoting bonding between protective coating 100 and muffle 20. For example, in some embodiments, muffle 20 is comprised of graphite, which has a CTE of about 4.5 to about 6.0 ppm/° C. at 1000° C. However, hafnium carbide (an exemplary material of second layers 120) has a CTE of about 6.8 ppm/° C. at 1000° C. Thus, a CTE mismatch exists between the material of muffle 20 and that of second layers 120, which could cause poor bonding between these materials. With such poor bonding, protective coating 100 can peel away from muffle 20, especially when exposed to the high temperatures from heater 60. Accordingly, the material of first layers 110, the thickness of first layers 110, and/or the number of individual first layers 110 can be selected to reduce the CTE mismatch between these materials.

In some embodiments, first layers 110 may reduce the CTE of protective coating 100 so that an absolute difference between the CTE of protective coating 100 and the CTE of the material of muffle 20, over a temperature range from 25° C. to 1000° C., is about 3.0 ppm/° C. or less, or about 2.5 ppm/° C. or less, or about 2.0 ppm/° C. or less, or about 1.5 ppm/° C. or less, or about 1.0 ppm/° C. or less, or about 0.7 ppm/° C. or less, or about 0.5 ppm/° C. or less, or about 0.2 ppm/° C. or less, or about 0.1 ppm/° C. or less, or about 0.05 ppm/° C. or less, or about 0.02 ppm/° C. or less, or about 0.01 ppm/° C. or less, or about 0.001 ppm/° C. or less. In one embodiment, muffle 20 is comprised of graphite and has a CTE of about 4.5 ppm/° C. at 1000° C. and protective coating 100 comprises a laminate structure of hafnium carbide and silicon carbide with an overall CTE of about 5.3 ppm/° C. at 1000° C. Thus, an absolute difference between the CTE of the material of muffle 20 and the CTE of protective coating 100, in this example, is 0.8 ppm/° C. It is also noted that in some embodiments, the CTE of protective coating 100 is equal to the CTE of the material of muffle 20 over a temperature range from 25° C. to 1000° C.

Both the material of muffle 20 and protective coating 100 may have a CTE, at 1000° C., in a range from about 4.0 ppm/° C. to about 7.5 ppm/° C., or from about 4.5 ppm/° C. to about 6.0 ppm/° C., or from about 5.0 ppm/° C. to about 5.5 ppm/° C.

Inner surface 26 of muffle 20 may have a surface roughness from about 0.1 microns to about 12 microns in order to increase the adhesion and bond between muffle 20 and protective coating 100. More specifically, inner surface 26 may have a surface roughness from about 0.2 microns to about 10 microns, or about 0.5 microns to about 5 microns, or about 1 micron to about 2 microns.

In some exemplary embodiments, protective coating 100 comprises alternating layers of hafnium carbide and silicon carbide. In one exemplary embodiment, protective coating 100 comprises ten layers total consisting of alternating layers of hafnium carbide and silicon carbide. Therefore, the protective coating comprises five layers of hafnium carbide and five layers of silicon carbide. One of the hafnium carbide layers forms an outer layer of protective coating, and one of the silicon carbide layers forms an inner layer that directly contacts inner surface 26 of muffle 20. In this exemplary embodiment, each hafnium carbide layer has a thickness of 10 microns and each silicon carbide layer has a thickness of 25 microns. Therefore, the protective coating has a total thickness of 175 microns. The protective coating extends for a length of 12 inches along inner surface 26 of muffle 20 such that the protective coating is disposed in the hot zone of the furnace. Additionally, the protective coating has a CTE of 6.0 ppm/° C. at 1000° C., and the muffle is formed of graphite and has a CTE of 6.3 ppm/° C. at 1000° C. Therefore, the absolute difference between the CTE of the protective coating and the graphite of the muffle is 0.3 ppm/° C.

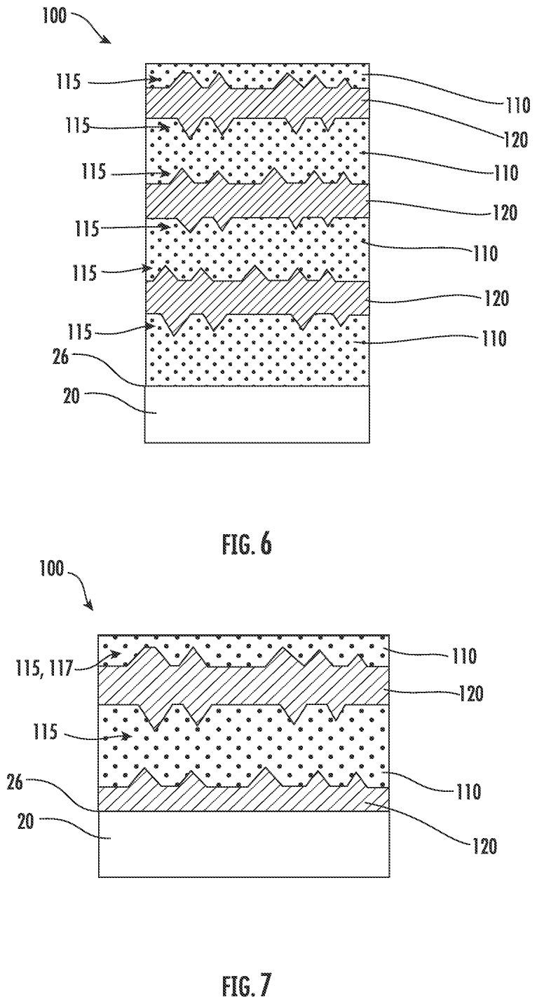

In some embodiments, first layers 110 may be intermixed with second layers 120, which can improve the life of protective coating 100 by reducing degradation of the coating. For example, as shown in FIG. 6, protective coating 100 is comprised of one or more first layers 110 and one or more second layers 120, as discussed above. Thus, for example, second layers 120 may be doped, as discussed above. However, in the embodiment of FIG. 6, at least one first layer 110 is intermixed with at least one second layer 120 to form intermixing region 115. Although the embodiment of FIG. 6 shows all first and second layers 110, 120 as being intermixed, it is also contemplated that less than all of the layers may be intermixed.

Intermixing region 115 may be formed of a mixture of the material(s) of first layer 110 and those of second layer 120. Furthermore, intermixing region 115 may be a gradient ranging from the material(s) of first layer 110 to the mixture of materials to the material(s) of second layer 120. In some embodiments, as discussed above, first layers 110 are comprised of silicon carbide and second layers 120 are comprised of hafnium carbide. Thus, in these embodiments, intermixing region 115 is comprised of hafnium silicide (HfSiₓ, where x is less than 1). Furthermore, in these embodiments, intermixing region 115 may be formed of a gradient ranging from silicon carbide to hafnium silicide to hafnium carbide.

Although FIG. 6 shows intermixing regions 115 as having triangular shapes, such is exemplary only and used for illustration purposes. Intermixing regions 115 may each vary in shape and size and may have irregular and non-uniform borders.

Intermixing regions 115 may be formed during the heating of preform 50, for example, when muffle 20 is heated to temperatures ranging from about 1500° C. to about 2200° C. In some embodiments, intermixing regions 115 are formed during the drawing of preform 50. Furthermore, intermixing region 115 provides a stable layer that impedes and defends against any etching of protective coating 100 (such as etching caused by the silicon monoxide gas and oxygen gas released from preform 50).

Furthermore, in the embodiment of FIG. 6, first layer 110 is disposed most outwardly of all the layers of protective coating 100. However, as discussed above, it is also contemplated that second layer 120 is disposed most outwardly of all the layers of protective coating 100. FIG. 7 shows an enlarged view of a portion of protective coating 100 of FIG. 6. As shown in FIG. 7, the most outwardly disposed intermixing region 117 can potentially be oxidized from the silicon monoxide gas and oxygen gas released from preform 50. Intermixing region 117 may potentially be oxidized because it is the outward most layer and therefore exposed to the environment of muffle 20. In the embodiments in which first layers 110 are comprised of silicon carbide and second layers 120 are comprised of hafnium carbide, intermixing regions 115 (including intermixing region 117) are formed of hafnium silicide, as discussed above. However, when intermixing region 117 is oxidized during the drawing of preform 50, the hafnium silicide of intermixing region 117 becomes hafnium silicate (HfSiOₓ, where x is less than 1).

In order to prevent or reduce such oxidation of intermixing region 117, embodiments of the present disclosure include pretreating intermixing region 117 to prevent or slow down the oxidizing process. For example, intermixing region 117 may be heated at a temperature in a range from about 1500° C. to about 2000° C. prior to drawing of preform 50. The heating of intermixing region 117 may be performed for a duration of about 2 minutes or more, or about 5 minutes or more, or about 10 minutes or more, or about 30 minutes or more. Additionally or alternatively, the duration may be about 2 hours or less, or about 1.5 hours or less, or about 1 hour or less, or about 45 minutes or less. In some embodiments, the duration may be in a range from about 2 minutes to about 2 hours, or about 15 minutes to about 1.75 hours, or about 25 minutes to about 1.5 hours. Furthermore, intermixing region 117 may be heated at a heating rate of about 30° C./min or less, or about 25° C./min or less, or about 20° C./min, or about 15° C./min or less, or about 10° C./min or less. Additionally or alternatively, the heating rate may be about 2° C./min or more, or about 5° C./min or more, or about 7° C./min or more, or about 10° C./min. In some embodiments, the heating rate is in a range from about 2° C./min to about 10° C./min, or from about 4° C./min to about 8° C./min. Such heating of intermixing region 117 may help to reduce any oxidizing of protective coating 100, specifically to reduce any oxidizing at intermixing region 117.

Protective coating 100 provides a stable covering on inner surface 26 of muffle 20 so that it does not chemically alter the structure or material of muffle 20. Additionally, protective coating 100 prevents the silica of preform 50 from reacting with and oxidizing the material of muffle 20. During a drawing procedure, as preform 50 is pulled downward towards heater 60 (with reference to FIG. 1), silica will continuously evaporate, releasing silicon monoxide gas and oxygen gas. These gases can then react with the material of muffle 20 if protective coating 10 is not present. As discussed above, such can waste time and money in order to stop production to clean and remove the oxidation residue on the muffle. However, protective coating 100 provides a barrier that advantageously prevents such oxidation from forming on the muffle.

What is claimed is:

1. A muffle for an optical fiber draw furnace, the muffle comprising:
an inner surface and an outer surface, the inner surface forming an inner cavity; and
a protective coating disposed on the inner surface, the protective coating having a melting point of about 1850° C. or greater,
wherein an absolute difference between a coefficient of thermal expansion of the protective coating and a coefficient of thermal expansion of a material of the muffle is 2.0 ppm/° C. or less over a temperature range from 25° C. to 1000° C.

2. The muffle of claim 1, wherein the muffle is comprised of graphite.

3. The muffle of claim 1, wherein the protective coating comprises at least one of hafnium, zirconium, and tantalum.

4. The muffle of claim 3, wherein the protective coating comprises hafnium carbide.

5. The muffle of claim 4, wherein the hafnium carbide is doped with tantalum.

6. The muffle of claim 4, wherein the protective coating further comprises silicon carbide.

7. The muffle of claim 1, wherein the material of the muffle and the protective coating each have a coefficient of thermal expansion at 1000° C. in a range from about 4.0 ppm/° C. to about 7.5 ppm/° C.

8. The muffle of claim 7, wherein the material of the muffle and the protective coating each have a coefficient of thermal expansion at 1000° C. in a range from about 4.5 ppm/° C. to about 6.0 ppm/° C.

9. The muffle of claim 1, wherein the absolute difference between the coefficient of thermal expansion of the protective coating and the coefficient of thermal expansion of the material of the muffle is 1.5 ppm/° C. or less over the temperature range from 25° C. to 1000° C.

10. The muffle of claim 1, wherein the protective coating comprises one or more first layers of a first material and one or more second layers of a second material, the first material being different from the second material.

11. The muffle of claim 10, wherein a total thickness of the protective coating is in range between about 2 microns and about 100 mm.

12. The muffle of claim 10, wherein a thickness of each first layer is in a range between about 0.2 microns and about 40 mm.

13. The muffle of claim 10, wherein a thickness of each second layer is in a range between about 0.1 microns and about 100 microns.

14. The muffle of claim 10, wherein a thickness of each first layer is greater than a thickness of each second layer.

15. The muffle of claim 10, further comprising an intermixing region between at least one of the first layers and one of the second layers, the intermixing region being a mixture of the first material and the second material.

16. The muffle of claim 1, wherein the protective coating has an average particle diameter of about 10 microns or less.

17. An optical fiber draw furnace comprising the muffle of claim 1.

18. The optical fiber draw furnace of claim 17, further comprising:
a downfeed handle moveably positioned within the inner cavity of the muffle; and
a heater configured to heat the inner cavity of the muffle.

19. A muffle for an optical fiber draw furnace, the muffle comprising:
an inner surface and an outer surface, the inner surface forming an inner cavity; and
a protective coating disposed on the inner surface, the protective coating having a melting point of about 1850° C. or greater, and a vapor pressure of the protective coating in an inert environment at about 1800° C. is about 2.0×10⁻⁸ Pa or less.

20. The muffle of claim 19, wherein the vapor pressure of the protective coating in an inert environment at about 1900° C. is about 6.0×10⁻⁸ Pa or less.

21. The muffle of claim 19, wherein the muffle is comprised of graphite.

22. The muffle of claim 19, wherein the protective coating comprises at least one of hafnium, zirconium, and tantalum.
